(19) United States
(12) Patent Application Publication
(10) Pub. No.: US 2016/0173969 A1
(43) Pub. Date: Jun. 16, 2016

(54) MULTIPLE POSITION EARPHONE CABLE EXIT

(71) Applicant: Frederick DeKalb, Ben Lomond, CA (US)

(72) Inventor: Frederick DeKalb, Ben Lomond, CA (US)

(21) Appl. No.: 14/951,459

(22) Filed: Nov. 24, 2015

Related U.S. Application Data
(60) Provisional application No. 62/092,146, filed on Dec. 15, 2014.

(51) Int. Cl. H04R 1/10

(52) U.S. Cl. CPC H04R 1/1033; H04R 1/1016; H04R 1/1083; H04R 2460/15; H04R 2460/01

(57) ABSTRACT

The invention provides earphones that provide a user with a choice of selectable, stable positions from which a wire exits the earphone. When the wire exits in an “up” position, it favors winding over the ear to a source or transmitter of electrical sound information. When the wire exits in a “down” position, it does not favor winding over the ear. The wire exits the earphone about parallel to the side of the user's face so that it does not protrude in an unsightly or unstable manner.

### FIELD OF THE INVENTION

The invention relates to earphones that provide a user with a choice of selectable, stable positions from which a wire exits the earphone.

### BACKGROUND OF THE INVENTION

Earpieces used for earphones (also called in-ear headphones or in-ear monitors) have a cable that can exit downwards below the ear or upwards, over and behind the ear. The cable is usually fixed in one of these orientations and cannot be switched between them. There are a small number of earphones/headphones that can be switched from the upper orientation to the lower orientation but they do so with swivels on the outside of the earpiece resulting in a bulky, unstable earphone.

### SUMMARY OF THE INVENTION

This invention provides a simple but very effective solution to this problem. The earphone cable can easily be moved from a lower position to an upper position of an earpiece (or visa versa) and retained there. The cable also exits close (about parallel) to the side of the face, for optimum stability. Thus, the invention provides a movable earphone or headphone cable between a plurality of positions that is retained in that position. Some of the positions favor the cable exiting up, over or behind the user's ear. Other positions favor the cable exiting down below the user's ear. The cable exits at an angle that is approximately a ±45 degree angle to the face or Frankfort plane and in line with the ear's natural channels. The earphone or headphone incorporates a plurality of slots with detent positions for engaging and retaining the cable at one of the plurality of detent positions.

Thus, the invention provides an earpiece, comprising a body portion that rests in a concha of a user's ear, a speaker that transmits sound through an orifice to an ear canal in the user's ear, and an attached wire that transmits electric sound signals to the speaker, wherein the wire is manually movable into a first plurality of positions or a second plurality of positions with respect to the body portion, wherein the first plurality of positions favor the wire exiting above a tragus of the user's ear, wherein the second plurality of positions favor said wire exiting below said tragus, wherein the earpiece retains the wire in the first or second position, and wherein the wire exits the ear at about a ±45 degree angle from a Frankfort plane of the user, and wherein the wire exits the user's ear about parallel to a side of the user's face.

In a preferred embodiment, the earpiece is an earbud. In another preferred embodiment, the earpiece comprises an ear tip that rests in a portion of the user's ear canal. In another preferred embodiment, the earpiece is molded to precisely fit the user's ear canal. In other preferred inventions, the earpiece comprises 2, 3, 4, 5, 6, 7, 8, 9, or 10 of said positions. In a most preferred embodiment, the earpiece comprises 2 positions.

In another embodiment, the earpiece reduces ambient sound passing through to the user's ear canal. In a more preferred embodiment, the ambient sound is reduced by a sound proofing material. In a most preferred embodiment, the sound proofing material is a foam, rubber, a polymer, a filter, or a fiber. In another preferred embodiment, the earpiece reduces the ambient sound using active noise-canceling.

The invention provides an in-ear musical monitor comprising the earpieces disclosed herein. In a preferred embodiment, the in-ear musical monitor uses active noise-canceling. In a more preferred embodiment, the user can adjust the amount of noise-canceling. The invention also provides an earpiece wherein the sound is transmitted to the earpiece from a shared, personal, or portable audio source.

In other embodiments, the ear pieces disclosed herein further comprise a microphone.

### BRIEF DESCRIPTION OF THE DRAWINGS

FIG. 1A shows an earphone on an ear with a cable extending from a slot in the earphone at an approximately parallel angle to a side of a user's face. The cable is in an “up” position so that the cable wraps around the top of the ear. FIG. 1B shows the earphone on an ear with the cable in a “down” position so that the cable does not wrap around the top of the ear.

FIG. 2 shows an exemplary embodiment where a cable extends from a slot in an earphone at an approximately parallel angle to a side of a user's face

FIG. 3 shows an embodiment of the invention. A cross-section of a wire housing is depicted showing two selectable positions formed by two holes having a larger diameter than the cable. A slot connects the holes that allows the cable to pass but is tighter so that the cable requires an amount of force to be moved from one position to the other.

### DETAILED DESCRIPTION OF THE INVENTION

The invention provides earphones that offer a user with a choice of selectable, stable positions from which a wire exits the earphone. When the wire exits in an “up” position, it favors winding over the ear to a source, transmitter, or receiver of electrical sound information. When the wire exits in a “down” position, it does not favor winding over the ear. The wire exits the earphone about parallel to the side of the user's face so that it does not protrude in an unsightly or unstable manner.

The cable exits the earpiece from a slot. The slot is tight on the cable but has larger opening portions where the cable is looser. These are the detent positions. In some embodiments, the larger openings may be circular, triangular, square, or take the form of another geometric shape. In some embodiments, the slot has 2, 3, 4, 5, 6, 7, 8, 9, or 10 openings. In other embodiments, the larger openings are at the end of the slot or distributed along the length of the slot. This arrangement allows the cable to be pulled into one of these detent positions where it is retained. The slot is close to the user's face and faces forwards toward the user's nose, roughly at the apex of the tragus.

The detent position at the upper end of the slot causes the cable to exit naturally above the tragus through the anterior notch and over the top of the ear. The lower detent position causes the cable to exit naturally though the intertragic incisure (between the tragus and antitragus).

This allows the user to easily select an over the ear or under the ear wearing option and also keeps the cable close to the face and positioned in the natural channels of the ear for optimum stability. The earphones of the invention are advantageous over the prior art because they do not require a bulky wire housing or swivel that extends from the ear at an angle that is about perpendicular to the side of the face. Such prior art arrangements are unsightly and can result in earphones that may fall our or be more easily pulled out accidentally.

The invention provides an earpiece that retains the wire in at least a first or second position, and wherein the wire exits the ear at about a ±45 degree angle from a Frankfort plane of a user. The “Frankfurt plane,” “Frankfort plane,” “Frankfort horizontal plane” or “ auriculo-orbital plane” is determined using the anatomical position of the human skull. It passes through the inferior margin of the left orbit (the point called the left orbitale) and the upper margin of each ear canal or external auditory meatus, a point called the porion. It is a plane that most nearly parallels the earth when a person is standing upright.

In some embodiments, the earpiece of the invention comprises an ear tip that rests in a portion of a user's ear canal. In a preferred embodiment, the ear tip is removable. In more preferred embodiments, ear tips of a plurality of size or shape may be swapped onto the earpiece. In another preferred embodiment, the ear tip has a plurality of flange sleaves for fitting securely into the ear canal.

In other embodiments, the earpiece is molded to fit a user's ear or ear canal. In preferred embodiments, the molded earpiece is made from foam, rubber, silicone, urethane, polyurethane, a polymer, a fiber, or a combination thereof.

In other embodiments, the earpiece of the invention comprises an earbud as is known in the art. See, e.g., U.S. Pat. No. 7,986,803 which is incorporated by reference herein in its entirety. Sound devices such as earphones and headphones are used extensively throughout the world. One style of earphone that is commonly used is referred to as an ear bud or an ear bud-type headphone. Ear buds are small speaker-like devices that are designed to fit within the external ear, that is, the concha or ear canal, of a user so that the user can listen to sound being transmitted from a sound source with a degree of acoustic isolation from environmental sound pollution.

When properly positioned in the ear, ear buds can provide the listener with acceptable sound transmission to the ear canal. Due to person-to-person variations and variations in the environment in which the ear buds are used, however, the earbud fit may not be adequate and extraneous noise may make transmission inadequate. In addition, improper fit can greatly degrade the sound quality (level and frequency response). This is particularly important when listening to music.

In other embodiments, the earpiece of the invention comprises passive soundproofing materials. Isolating an ear from other sounds (i.e. sounds not originating from the sound device) allows the user to better process sound coming from the sound device, even when the device is only in one ear with the other ear receiving extraneous environmental sounds. This allows the user to better distinguish the sounds from the sound device from other sounds that could be distracting. This feature may be particularly useful when the sound device is an earbud connected to a telephone because the user would be able to adequately hear and distinguish voices from the telephone from other sounds or voices that might be present in the area. This feature also reduces the likelihood that sounds originating from the sound device would be confused with extraneous sounds, even when the user's other ear does not have any sound device disposed therein.

Moreover, by reducing the amount of unwanted sound that enters the ear, a lesser degree of energy can be delivered to the eardrum for the same level of sound perception and intelligibility. This can protect the eardrum from damage that could be caused by exposure to greater amounts of energy or otherwise help preserve or enhance the long-term health of the ear.

In some embodiments, the earpiece provides active noise cancellation (ANC), also known as noise control, or active noise reduction (ANR). ANC is a method for reducing unwanted sound by the addition of a second sound specifically designed to cancel the first. Sound is a pressure wave that consists of alternating periods of compression and rarefaction. A noise-cancellation speaker emits a sound wave with the same amplitude but with an inverted phase (i.e. antiphase) to the original sound. The waves combine to form a new wave, in a process called interference, and effectively cancel each other out. This is called destructive interference.

Modern active noise control is generally achieved through the use of analog circuits or digital signal processing. Adaptive algorithms are designed to analyze the waveform of the background aural or nonaural noise, then based on the specific algorithm, generate a signal that will either phase shift or invert the polarity of the original signal creating the antiphase. It is then amplified and a transducer creates a sound wave directly proportional to the amplitude of the original waveform, creating the destructive interference. This effectively reduces the volume of the perceivable noise.

Current noise cancelation techniques may include a set of speakers and a set of microphones in each earpiece of a noise canceling headphone. The microphones are typically positioned in proximity to the outside of the ear cups to detect the ambient noise, whereas the speaker may also be positioned on the inside of the ear cup to subtract the ambient noise from the intended audio that is also played into the ear on the inside of the ear cups. To do the processing, headphones may include a processor to receive the input from the ambient noise detecting microphones on the outside of the ear cup, then calculate the noise estimate, and then play back the inverted (or negative) version of the ambient noise from the speakers on the inside of the ear cup. The processor may also scale the noise estimate because there is inherent isolation from the outside of the ear cups to the inside, which reduces the level of ambient noise on the inside of the ear cups. Since this process takes some processing power from an electronic computation device, the noise canceling headphones may require batteries as well. See, e.g. U.S. Pub. No. 2015/0243272, incorporated herein by reference in its entirety.

In more preferred embodiments, the user can vary the amount of active noise cancellation using a manual or electronic controller

In some embodiments, the earpiece of the invention plays sounds from shared, personal, or portable audio sources. In preferred embodiments, the audio sources are broadcast radios, two way radios, televisions, video monitors, cassette players, compact disc players, DVD players, wireless telephones, wired telephones, cellular telephones, tablet devices, computers, and other digital audio file players. In preferred embodiments, the digital audio files are uncompressed audio formats such as WAV, AIFF, AU or raw header-less PCM. In other preferred embodiments, the digital audio files have lossless compression such as FLAC, Monkey's Audio (filename extension .ape), WavPack (filename extension .wv), TTA, ATRAC Advanced Lossless, ALAC (filename extension .m4a), MPEG-4 SLS, MPEG-4 ALS, MPEG-4 DST, Windows Media Audio Lossless (WMA Lossless), and Shorten (SHN). In other preferred embodiments, the digital audio files have lossy compression such as Opus, MP3, Vorbis, Musepack, AAC, ATRAC and Windows Media Audio Lossy (WMA lossy).

The invention provides in-ear monitors (IEMs) used by musicians, audio engineers or audiophiles to hear music or a personal mix of vocals and stage instrumentation for live performance or recording studio mixing. They are often custom fitted for an individual's ears to provide comfort and a high level of noise reduction from ambient surroundings. In some embodiments, performers wear an IEM in each ear and can hear a stereo mix. This can allow additional definition of the audio by panning different elements to each ear. Preferred embodiments incorporate an ambient feature, allowing them to adjust the amount of ambient noise filtered by the IEM.

Some embodiments comprise an over-the-air transmission to the IEMs using a UHF or VHF frequency. This system contains a transmitter and a receiver pack that is worn by the performer. There is generally a transmitter for each monitor mix and there is always a receiver for each IEM. The transmitters usually output either one stereo mix or two mono mixes. When the transmitters are set up for two mono mixes, one transmitter can be used for two different mixes. Any number of receivers can receive a single mix.

In some embodiments, the IEM cable plugs into a 3.5 mm stereo jack on a receiver pack. In preferred embodiments, the receiver pack is clipped onto the belt, instrument strap, clothing, or placed in a pocket. In other embodiments, IEMs comprise foam or silicone tips. In other embodiments, the IEM is molded to fit a user's ear or ear canal. In preferred embodiments, the molded IEM is made from foam, rubber, silicone, urethane, polyurethane, a polymer, a fiber, or a combination thereof.

In order that the invention described herein may be more fully understood, the following examples are set forth. It should be understood that these examples are for illustrative purposes only and are not to be construed as limiting this invention in any manner.

### EXAMPLE

An exemplary earpiece of the invention was made as follows and illustrated in

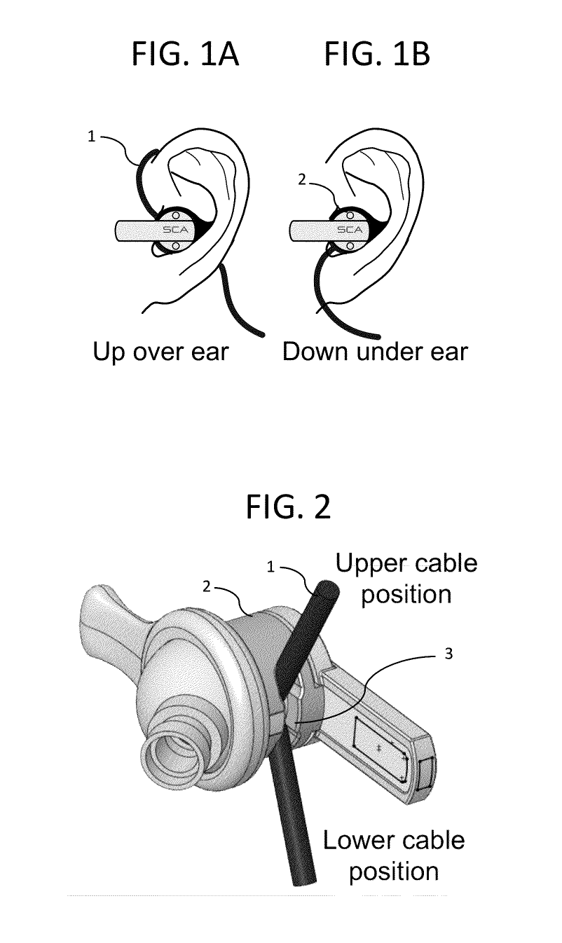

FIGS. 1-3. In FIG. 1, an earpiece sits in the ear with the wire 1 extending from the body 2 in an up detent position or a down detent position. FIG. 2 shows the same earpiece outside of an ear with the wire 1 extending from the body 2 in an up or down detent position. A slot 3 allows movement of the wire 1 to the detent positions. The wire 1 is retained in the positions by the narrowing of the slot between the positions. This results in resistance to wire movement but not prevention of said movement.

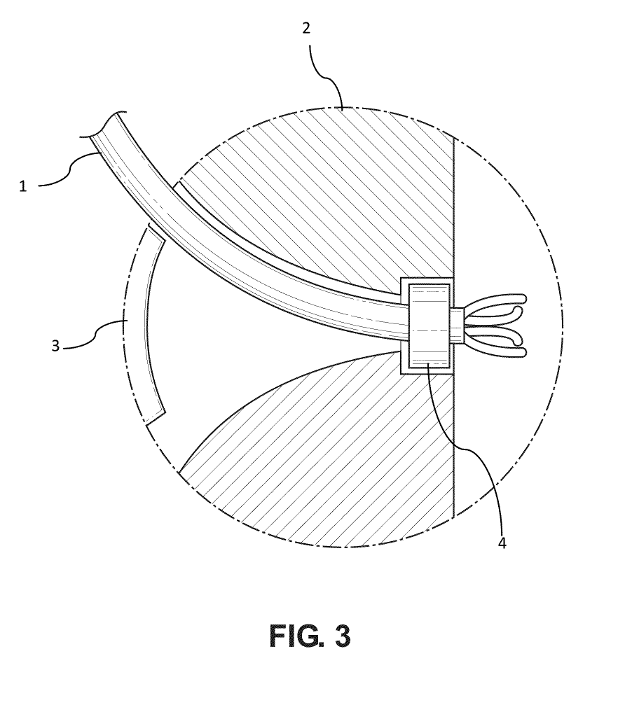

FIG. 3 shows a cross section of the body 2 and the positioning of the wire 1 and slot 3. A retainer such as a crimp 4 keeps the wire in the body 2 and prevents disconnection from a circuit that includes a speaker and optionally other electronic audio components inside the earpiece. Other embodiments of the retainer 4 may include a movable housing that rotates with the wire but retains the integrity of the circuit.

All publications and patent documents disclosed or referred to herein are incorporated by reference in their entirety. The foregoing description has been presented only for purposes of illustration and description. This description is not intended to limit the invention to the precise form disclosed. It is intended that the scope of the invention be defined by the claims appended hereto.

What is claimed:

1. An earpiece, comprising a body portion that rests in a concha of a user's ear, a speaker that transmits sound through an orifice to an ear canal in said user's ear, and an attached wire that transmits electric sound signals to said speaker, wherein said wire is manually movable into a first plurality of positions or a second plurality of positions with respect to said body portion, wherein said first plurality of positions favor said wire exiting above a tragus of said user's ear, wherein said second plurality of positions favor said wire exiting below said tragus, wherein said earpiece retains said wire in said first or second position, and wherein said wire exits the ear at about a ±45 degree angle from a Frankfort plane of said user, and wherein said wire exits said user's ear about parallel to a side of said user's face.

2. The earpiece of claim 1, wherein said earpiece is an earbud.

3. The earpiece of claim 1, wherein said earpiece comprises an ear tip that rests in a portion of said user's ear canal.

4. The earpiece of claim 1, wherein said earpiece is molded to precisely fit said user's ear canal.

5. The earpiece of claim 1 comprising 2, 3, 4, 5, 6, 7, 8, 9, or 10 of said positions.

6. The earpiece of claim 5, wherein said earpiece comprises 2 positions.

7. The earpiece of claim 1, wherein said earpiece reduces ambient sound passing through to said user's ear canal.

8. There earpiece of claim 7, wherein said ambient sound is reduced by a sound proofing material.

9. The earpiece of claim 8, wherein said sound proofing material is a foam, rubber, a polymer, a filter, or a fiber.

10. The earpiece of claim 7, wherein said earpiece reduces said ambient sound using active noise-canceling.

11. An in-ear musical monitor comprising the earpiece of claim 7.

12. An in-ear musical monitor comprising the earpiece of claim 10.

13. The in-ear musical monitor of claim 11, wherein said user can adjust the amount of noise-canceling.

14. The earpiece of claim 1, wherein said sound is transmitted to said earpiece from a shared audio source.

15. The earpiece of claim 1, wherein said sound is transmitted to said earpiece from a personal audio source.

16. The earpiece of claim 1, wherein said sound is transmitted to said earpiece from a portable audio source.

17. The earpiece of claim 1, further comprising a microphone.
